(19) United States
(12) Patent Application Publication
(10) Pub. No.: US 2026/0116306 A1
(43) Pub. Date: Apr. 30, 2026

(54) LUGGAGE STORAGE STRUCTURE

(71) Applicants: HAYASHI TELEMPU CORPORATION, Nagoya-shi (JP); TOYOTA JIDOSHA KABUSHIKI KAISHA, Toyota-shi (JP)

(72) Inventors: Masahiko FUKUDA, Nagoya-shi (JP); Motoya KIMURA, Toyota-shi (JP)

(73) Assignees: HAYASHI TELEMPU CORPORATION, Nagoya-shi (JP); TOYOTA JIDOSHA KABUSHIKI KAISHA, Toyota-shi (JP)

(21) Appl. No.: 19/367,047

(22) Filed: Oct. 23, 2025

(30) Foreign Application Priority Data
Oct. 25, 2024 (JP) 2024-188211

(51) Int. Cl. B60R 5/04

(52) U.S. Cl. CPC B60R 5/045

(57) ABSTRACT

A luggage storage structure includes a flat surface portion, a vertical wall portion, and first and second movable panels. The first movable panel includes a first position and a second position. The second movable panel includes a first position which is adjacent to the front end of the first movable panel in the first position, and in a second position that overlaps the first movable panel in the second position. The luggage storage structure selectively assumes a first form in which a storage space is formed by the first and second movable panels in the first position, the vertical wall portion, and the flat surface portion, and a second form in which a storage space is at least partially defined by the vertical wall portion and stacked bodies comprising the first and second movable panels in the second position and the flat surface portion.

### TECHNICAL FIELD

This invention relates to a luggage storage structure.

### BACKGROUND TECHNOLOGY

As a luggage storage structure for passenger cars and other vehicles, JP7032960B discloses a structure in which two side boxes and a center box located between the two side boxes are arranged side by side in a luggage compartment of a vehicle. Both the side boxes and the center box are box members that each have an opening in at least a part of the top. The center box is independent of the side boxes and can be removed from or attached to the luggage compartment of the vehicle. In this structure, a lower storage space is provided below the center box and side boxes in which a spare tire and other items are stored. The center box and side boxes located above this lower storage space each constitute upper storage spaces.

### SUMMARY OF INVENTION

In the structure described in JP7032960B, at least three box members are located in the luggage compartment of the vehicle. Attaching these box members to the vehicle body is therefore time-consuming. Furthermore, the weight of the box members may add to the weight of the vehicle and the increase in the number of parts may increase the cost. In addition, the storage volume of these box members, especially the center box located above the lower storage space and between the two side boxes, may be insufficient.

An object of the present invention, therefore, is to provide a luggage storage structure that can be easily configured to ensure sufficient capacity while suppressing increases in weight and cost.

A luggage storage structure of the present invention comprises: a flat surface portion of a floor member that is placed on a floor of a vehicle; a vertical wall portion extending from the floor toward the interior of the vehicle; a first movable panel that can be selectively positioned in a first position in which, along the flat surface portion, the first movable panel faces the flat surface portion and is spaced from the flat surface portion, and in a second position in which the first movable panel faces the flat surface portion and is closer to the flat surface portion than the first position; and a second movable panel that can be selectively positioned in a first position in which the second movable panel is adjacent to an end of the first movable panel in the first position that is opposite to the vertical-wall-portion-side, in which the second movable panel is oriented in a direction that intersects with the flat surface portion, and in which the second movable panel faces the vertical wall portion and is spaced from the vertical wall portion and in a second position that overlaps the flat surface portion and the first movable panel in the second position, wherein the luggage storage structure can selectively assume: a first form in which a storage space is formed surrounded by the first movable panel in the first position, the second movable panel in the first position, the vertical wall portion, and the flat surface portion; and a second form in which a storage space is at least partially defined in two directions and formed by the vertical wall portion and stacked bodies comprising the first movable panel in the second position, the second movable panel in the second position, and the flat surface portion.

The vertical wall portion may be integrally formed with the flat surface portion of the floor member.

The first movable panel in the first position may be able to be opened and closed by pivoting around an end on the vertical wall portion side or around an end opposite to the vertical wall portion side.

At least one of the vehicle interior paneling and the floor member may be provided with a convexo-concave portion that can hold the first movable panel in the first position and in the second position, and a convexo-concave portion that can hold the second movable panel in the first position and in the second position.

The first movable panel and the second movable panel may each comprise a plurality of plate members, the plate members being unconnected and independent of each other.

According to the present invention, a luggage storage structure can be provided that can be easily configured to ensure sufficient capacity while suppressing increases in weight and cost.

### BRIEF DESCRIPTION OF THE DRAWING

FIG. 1 is a side view of a first form of a luggage storage structure of the present invention.

FIG. 2 is a side view of a second form of the luggage storage structure shown in FIG. 1.

FIG. 3A is a side view of the luggage storage structure shown in FIG. 1 with the first movable panel in an open state.

FIG. 3B is a side view of the luggage storage structure shown in FIG. 1 with the first movable panel in the other open state.

FIG. 4 is a side view of the second form of the luggage storage structure shown in FIG. 1 with a larger storage space.

FIG. 5 is an oblique view of the second form of the luggage storage structure shown in FIG. 1 with a larger storage space.

FIG. 6 is an oblique view from the lower side of the first movable panel of the luggage storage structure shown in FIG. 1.

FIG. 7 is an enlarged oblique view of the main part of the first form of the luggage storage structure shown in FIG. 1.

FIG. 8 is an oblique view from the lower side of the second movable panel of the luggage storage structure shown in FIG. 1.

FIG. 9A is an enlarged oblique view of the main part of the second movable panel of the luggage storage structure shown in FIG. 1.

FIG. 9B is an enlarged oblique view of the main part of the flat surface portion of the floor member of the luggage storage structure shown in FIG. 1.

FIG. 9C is an enlarged oblique view of the luggage storage structure shown in FIG. 1 in a state in which the second movable panel is attached to the flat surface portion of the floor member.

FIG. 10A is an enlarged oblique view of the main part of the floor member of the luggage storage structure shown in FIG. 1.

FIG. 10B is an enlarged oblique view, viewed from a different angle than in FIG. 10A, of the main part of the floor member of the luggage storage structure shown in FIG. 1.

FIG. 11A is a schematic side view of the first form of the luggage storage structure of the present invention.

FIG. 11B is a schematic side view of the second form of the luggage storage structure of the present invention.

FIG. 11C is a schematic side view of a variation of the first form of the luggage storage structure of the present invention.

FIG. 11D is a schematic side view of another variation of the first form of the luggage storage structure of the present invention.

FIG. 12A is a schematic side view of still another variation of the first form of the luggage storage structure of the present invention.

FIG. 12B is a schematic side view of still another variation of the second form of the luggage storage structure of the present invention.

### EMBODIMENTS OF THE INVENTION

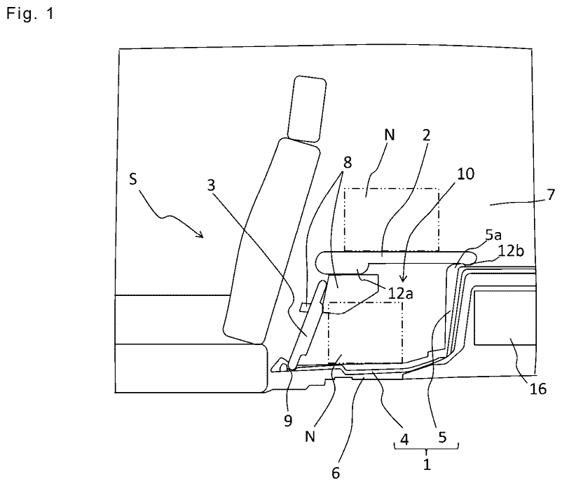

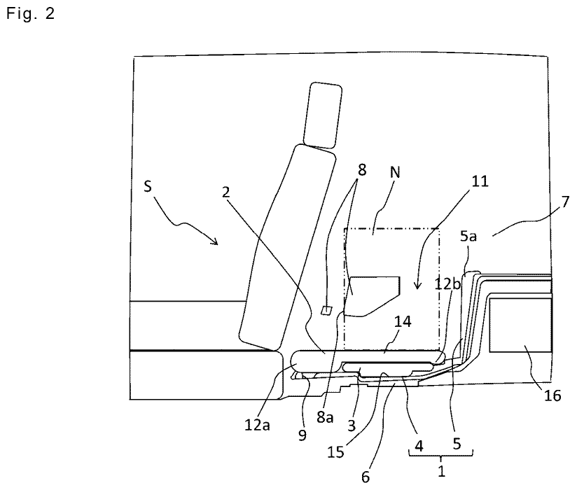

An embodiment of the present invention is next described with reference to the drawings. FIG. 1 is a side view of a first form of the luggage storage structure of this embodiment. FIG. 2 is a side view of a second form of this luggage storage structure. The luggage storage structure of the present invention is mainly installed behind rear seats S of a passenger car to accommodate, for example, luggage of passengers and tools. This luggage storage structure includes floor member 1 which is generally provided in a vehicle, first movable panel 2, and second movable panel 3. Floor member 1 has flat surface portion 4 that overlies floor 6 of the vehicle, and vertical wall portion 5 that extends toward the interior of the vehicle from floor 6 and flat surface portion 4.

First movable panel 2 can be selectively positioned in at least two positions (first position and second position). In the first position shown in FIG. 1, first movable panel 2 faces flat surface portion 4 of floor member 1 and is spaced from flat surface portion 4 along flat surface portion 4. In the second position shown in FIG. 2, first movable panel 2 faces flat surface portion 4 but is closer to flat surface portion 4 than in the first position.

Second movable panel 3 can also be selectively positioned in at least two positions (first position and second position). In the first position shown in FIG. 1, second movable panel 3 is adjacent to the edge of first movable panel 2 in the aforementioned first position on the side (front side) opposite vertical wall 5 portion, is oriented generally vertically from this adjacent portion in a direction that intersects with (in one example, is orthogonal to) flat surface portion 4, and faces vertical wall portion 5 at a distance from vertical wall portion 5. In the second position, second movable panel 3 overlies flat surface portion 4 along flat surface section 4 with first movable panel 2 in the aforementioned second position stacked above second movable panel 3. At least one of vehicle interior paneling 7 and floor member 1 is provided with convexo-concave portions 8 and 9 for holding each of first movable panel 2 and second movable panel 3 in the first positions. Convexo-concave portions 8 and 9 may each be a convex portion, a concave portion, or a combination of convex portion and concave portion.

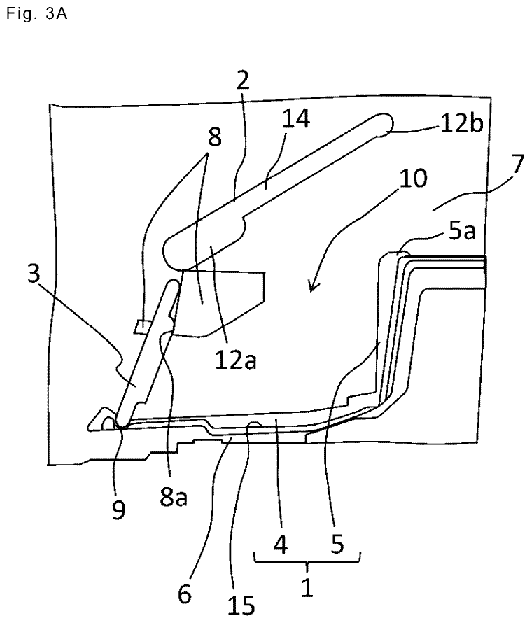

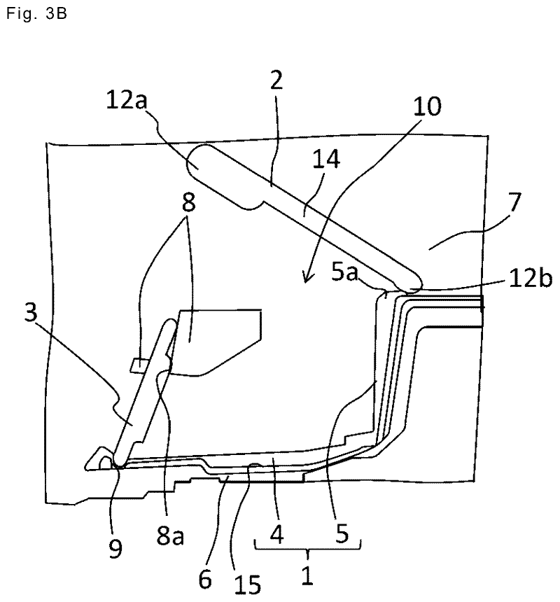

This luggage storage structure can selectively assume a first form (see FIG. 1), in which first movable panel 2 and second movable panel 3 are each in the first positions, and a second form (see FIG. 2), in which first movable panel 2 and second movable panel 3 are each in the second positions. In the first form, storage space 10 is formed surrounded by first movable panel 2 in the first position, second movable panel 3 in the first position, flat surface portion 4, and vertical wall portion 5. Vertical wall portion 5 of floor member 1 is the rear wall of storage space 10. Flat surface portion 4 is the bottom of storage space 10. Second movable panel 3 is the front wall of storage space 10. First movable panel 2 is the ceiling of storage space 10. First movable panel 2 in the first position can be opened and closed by pivoting around the end (front side end) opposite to the vertical-wall-5 side as shown in FIG. 3a, or by pivoting around the end (rear side end) on the vertical-wall-5 side as shown in FIG. 3b. Accordingly, first movable panel 2 in the first position becomes the upper lid of storage space 10. In a state in which first movable panel 2 is opened, luggage N and the like can be inserted into storage space 10 from above. First movable panel 2 can then be closed to close storage space 10 in which the luggage N is accommodated. Furthermore, other luggage N can be placed on closed first movable panel 2.

On the other hand, in the second form, second movable panel 3 is placed on flat surface portion 4 of floor member 1, and first movable panel 2 is placed on second movable panel 3. In other words, the stacked bodies comprising flat surface portion 4, second movable panel 3, and first movable panel 2 constitute the bottom of luggage storage space 11. Vertical wall portion 5 of floor member 1 is the rear wall of this luggage storage space 11. There is no front side wall or upper lid of storage space 11. However, in place of the front wall of storage space 11, rear seat S of the vehicle constitutes a substantial partition. In both the first form and second form, the side walls of storage spaces 10 and 11 are constituted by interior paneling 7 of the vehicle.

The luggage storage structure of this embodiment does not have a box member for luggage storage but has two movable panels (first movable panel 2 and second movable panel 3). In the first form, first movable panel 2, second movable panel 3, flat surface portion 4, and vertical wall portion 5 form a shape similar to a box member, and luggage N and the like can be accommodated in storage space 10 surrounded by these elements. First movable panel 2 and second movable panel 3 can then be moved to assume the second form to form another storage space 11. The user can freely decide whether to use the first or second form depending on, for example, the size and shape of luggage N. For example, if luggage N is small, the luggage storage structure is arranged in the first form and luggage N is accommodated in box-shaped storage space 10 surrounded by first movable panel 2, second movable panel 3, flat surface section 4, and vertical wall section 5. Because second movable panel 3 is present as the front wall of storage space 10, luggage N in storage space 10 is prevented from rolling out toward the seat-S side. When first movable panel 2 is closed, it is also possible to place yet another article of luggage N on first movable panel 2.

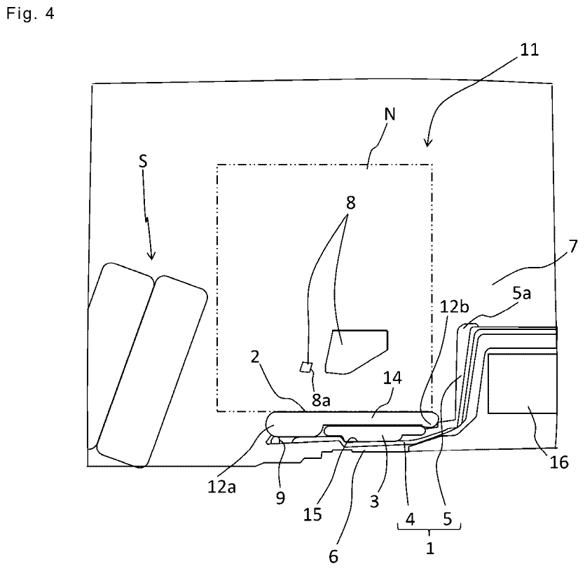

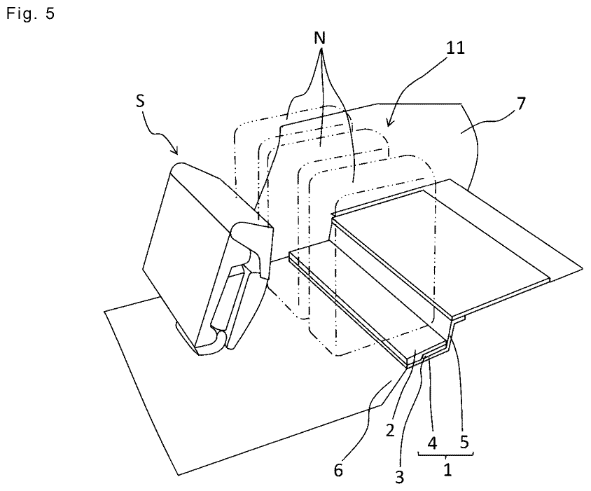

On the other hand, if luggage N is large, first movable panel 2 and second movable panel 3 are moved to arrange the luggage storage structure into the second form, and luggage N is accommodated in larger storage space 11, which is partially demarcated by vertical wall section 5 and the stacked bodies of first movable panel 2, second movable panel 3, and flat surface portion 4. Furthermore, when seat S is folded and tilted forward (tumbled) as shown in FIGS. 4 and 5, storage space 11 can be made even larger. In this way, for example, as shown in FIG. 5, luggage N in the form of large suitcases can be positioned along the front and rear directions of the vehicle, and a larger number of suitcases can be accommodated than before.

As explained above, the luggage storage structure of this embodiment can selectively assume the first form shown in FIGS. 1, 3A, and 3B, the second form shown in FIG. 2, and a further extended form from the second form shown in FIGS. 4 and 5, and thus can flexibly adapt to the size and number of articles of luggage N. The luggage storage structure of this embodiment does not require a box member for luggage storage as in the conventional luggage storage structure, but rather, requires only two movable panels 2 and 3, whereby the number of parts and cost is reduced. The box members of the conventional luggage storage structure are fixed to the car body and cannot be removed or moved by the user. In this embodiment, in contrast, first movable panel 2 is not connected to second movable panel 3 or to other members (e.g., interior paneling 7) and as a result, movable panels 2 and 3 can easily be moved freely. As a result, a large degree of freedom is provided for accommodating luggage. In the luggage storage structure of this embodiment, the side walls (walls in the width direction of the vehicle) of storage spaces 10 and 11 are constituted by interior paneling 7 of the vehicle, and because the side walls are not provided as separate components, the side dimensions of storage spaces 10 and 11 can be increased, further increasing the luggage storage capacity.

Since first movable panel 2 is not connected to second movable panel 3 or other components, first movable panel 2 can be opened rearward as shown in FIG. 3A or forward as shown in FIG. 3B. However, although not shown, first movable panel 2 and second movable panel 3 may be connected. Although not shown, a belt (strap) is preferably provided for pulling first movable panel 2 upward to open and close first movable panel 2.

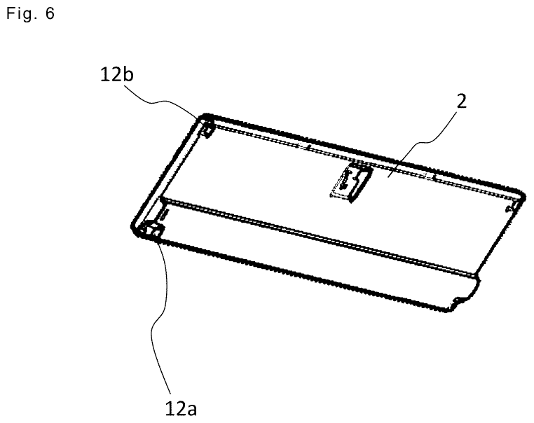

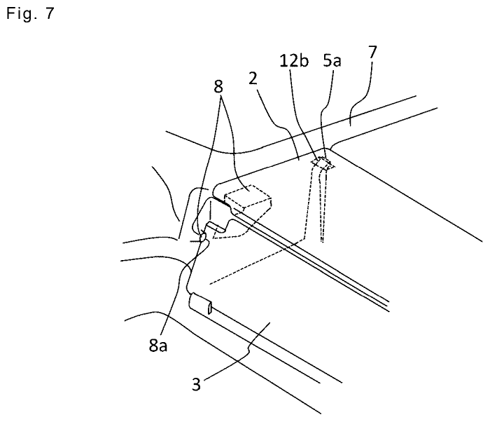

First movable panel 2 and second movable panel 3 are preferably provided with engaging protrusions or depressions to hold them stably in the first and second positions. For example, as shown in FIG. 6, front side convex portion 12a and rear side convex portion 12b are provided on the lower surface of first movable panel 2 on the side portions that are in proximity to interior paneling 7. Interior paneling 7 has convex portion 8 that supports first movable panel 2 at a position that is in front of the first position of first movable panel 2. As shown in FIGS. 1 and 7, first movable panel 2 is supported on convex portion 8, and convex portions 12a and 12b on the underside of first movable panel 2 engage with convex portion 8 of interior paneling 7 and convex portion 5a of vertical wall portion 5, respectively, of floor member 1. First movable panel 2 is positioned and stably held in the front and rear direction of the vehicle. In the illustrated embodiment, interior paneling 7 and vertical wall portion 5 of floor member 1 are provided with convex portions 8 and 5a for engaging with first movable panel 2. However, although not shown in the drawings, concave portions may be provided in interior paneling 7 and floor member 1 that can engage convex portions 12a and 12b on the underside of first movable panel 2.

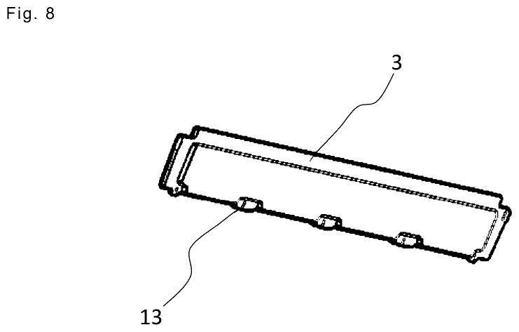

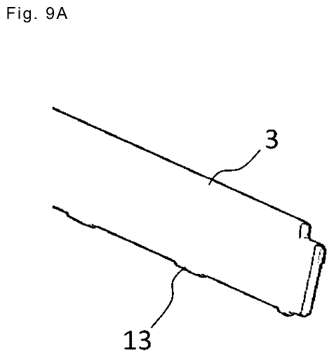

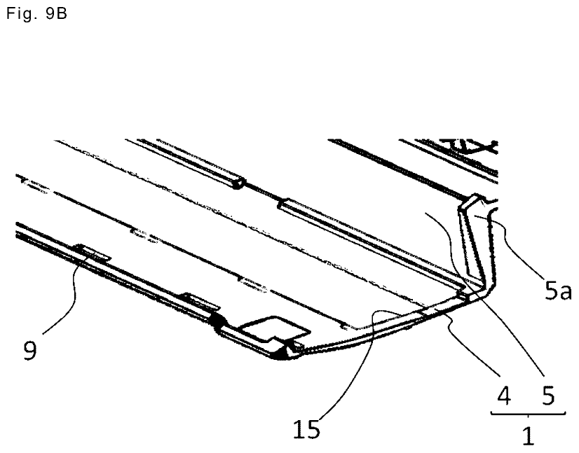

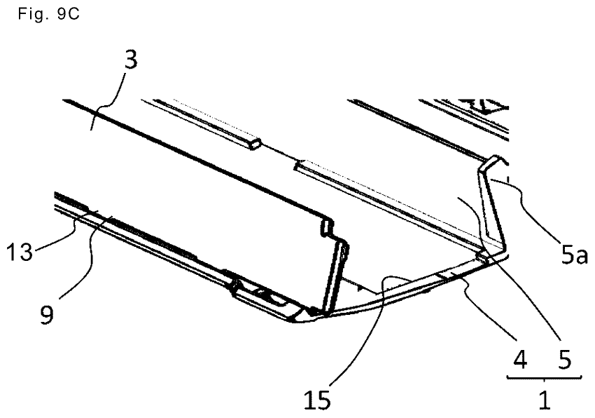

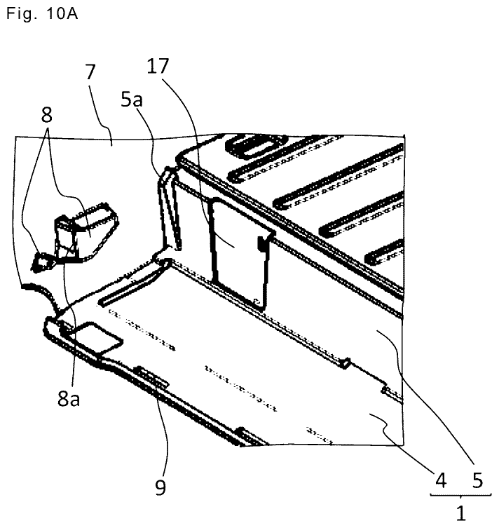

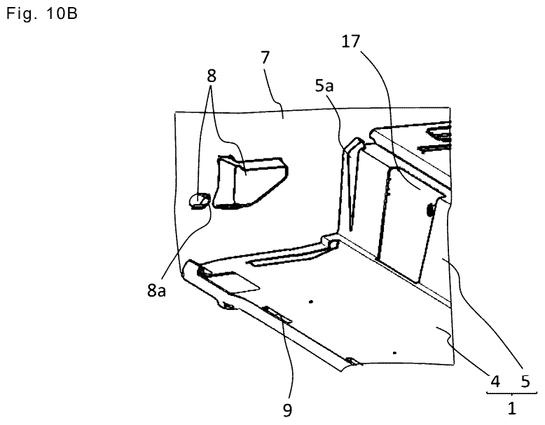

As shown in FIGS. 8 and 9A, convex portions 13 are provided at the front end of second movable panel 3. As shown in FIGS. 9B, 10A, and 10B, concave portions 9 are provided in flat surface portion 4 of floor member 1 at the positions where the front end portion of second movable panel 3 contacts flat surface portion 4 in the first position. As shown in FIG. 9C, convex portions 13 of second movable panel 3 are inserted into concave portions 9, and second movable panel 3 is inserted through groove 8a provided in convex portion 8 of interior paneling 7, whereby second movable panel 3 is positioned in the first position by concave portions 9 in the flat surface portion of floor member 1 and groove 8a in convex portion 8 of interior paneling 7 and is held stably so that it does not collapse in the forward or rearward direction. In the illustrated embodiment, concave portions 9 are provided in flat surface portion 4 of floor member 1. However, although not shown in the drawings, convex portions may be provided in flat surface portion 4 to allow, for example, each convex portion 13 of second movable panel 3 to be engaged between a plurality of the convex portions.

Thus, in this embodiment, either or both of vehicle interior paneling 7 and floor member 1 are provided with concavo-convex portions 8 and 9 (these portions each being a concave portion, a convex portion, or a combination of a convex portion and a concave portion). Movable panels 2 and 3 can be easily positioned and supported by simply placing or inserting them on concavo-convex portions 8 and 9. Since there is no need for separate parts such as hooks or locking mechanisms to engage movable panels 2 and 3, the assembly process is simple as well as inexpensive.

Movable panels 2 and 3 in this embodiment comprise portions having different thicknesses. Specifically, first movable panel 2 is provided with thin portion 14. In the second form in which first movable panel 2 and second movable panel 3 are stacked, the upper portion of second movable panel 3 is partially accommodated by thin portion 14 of first movable panel 2. Furthermore, concave portion 15 is provided in flat surface portion 4 of floor member 1, and the lower part of second movable panel 3 is partially accommodated in concave portion 15 of flat surface portion 4. By providing thin portion 14 and concave portion 15, the thickness of the stacked bodies comprising first movable panel 2, second movable panel 3, and the flat surface portion 4 can be made thinner to further increase storage space 11. However, a configuration that lacks thin portion 14 and concave portion 15 may also be adopted. Although not shown in the drawings, first movable panel 2 and second movable panel 3 can be made hollow while maintaining the thickness of first movable panel 2 and second movable panel 3 to achieve both strength and light weight.

In the example shown in FIGS. 1 and 2, battery 16 is located in the space behind vertical wall section 5, which is the rear wall of storage spaces 10 and 11. In other words, vertical wall portion 5 constitutes a cover for battery 16. As shown in FIGS. 10A and 10B, vertical wall portion 5 has access door 17 that can be opened and closed. By opening this access door 17, battery 16 can be accessed from the storage-space-10, 11 side for maintenance. Furthermore, since first movable panel 2 and second movable panel 3 can be moved freely in the present invention, removing first movable panel 2 and second movable panel 3 allows battery 16 to be more easily accessed to perform maintenance.

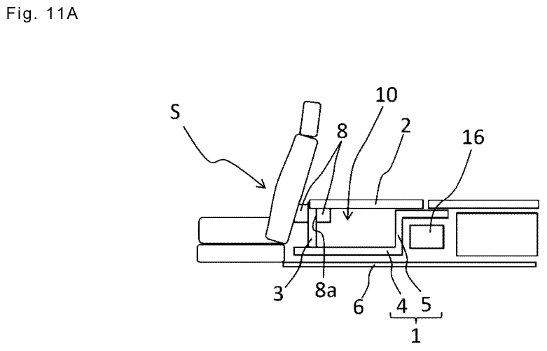

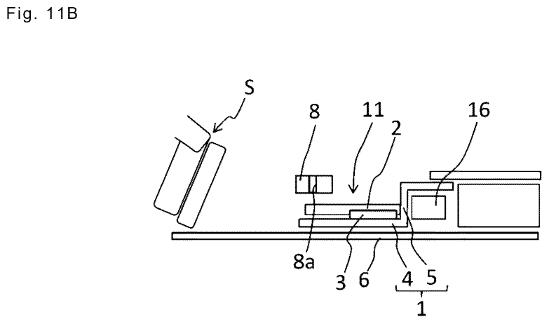

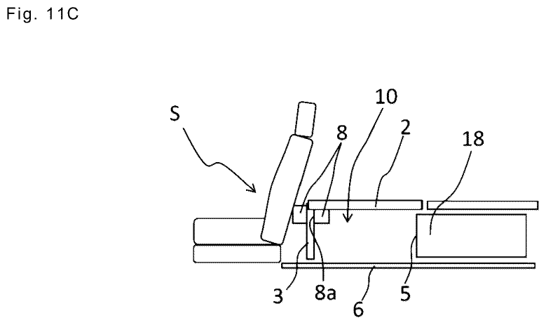

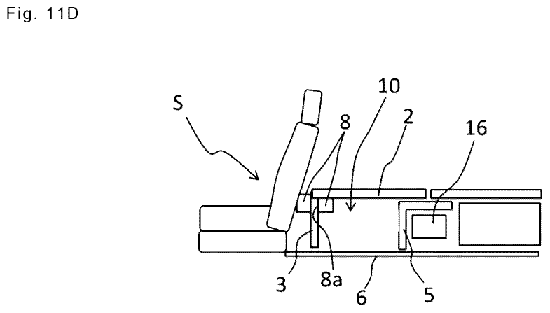

As schematically shown in FIGS. 11A and 11B, flat surface portion 4 of floor member 1 and vertical wall section 5 in the structure described above are used as part of the walls that define storage spaces 10 and 11. However, the structure is not limited to this form. For example, as shown in FIG. 11C, a portion of box member 18 that is arranged separately from floor member 1 at the rear of the vehicle can be used as vertical wall portion 5 that constitutes the rear wall of storage spaces 10 and 11. In addition, as shown in FIGS. 11C and 11D, floor 6 of the vehicle itself rather than flat surface portion 4 of floor member 1 can be used as the bottom of storage spaces 10 and 11.

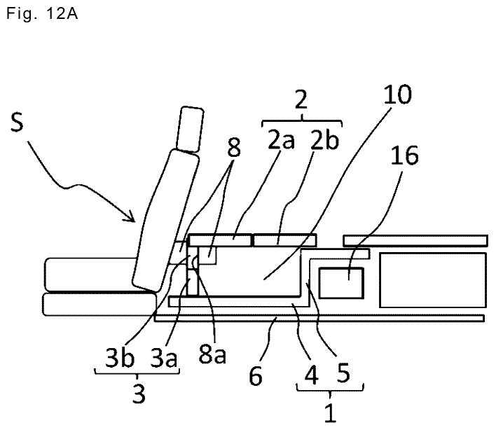

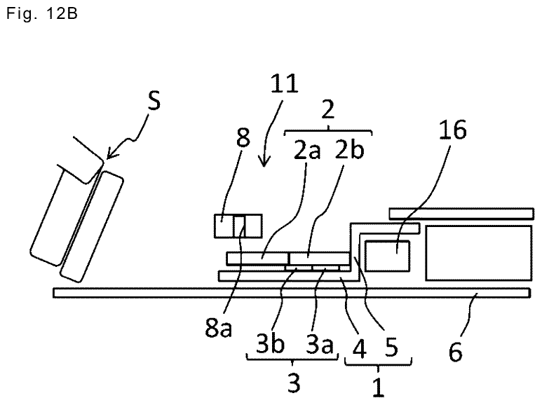

As shown schematically in FIGS. 12A and 12B, first movable panel 2 may comprise a plurality of plate members 2a and 2b, and plate members 2a and 2b may also be configured to be unconnected and independent of each other. Similarly, second movable panel 3 may comprise a plurality of plate members 3a and 3b and plate members 3a and 3b may be configured to be unconnected and independent of each other. According to this structure, only a portion of first movable panel 2 and second movable panel 3 can be moved or removed in order to efficiently accommodate luggage N of various shapes and dimensions. In such a case, although not shown in the drawings, interior paneling 7 or the like is preferably provided with convexo-concave portions or the like to support each of independent plate members 2a, 2b, 3a, and 3b.

As explained above, according to the invention, instead of using the inside of a box member, which is difficult to remove, as a luggage storage space, two movable panels 2 and 3 are used to configure storage spaces 10 and 11, whereby the storage space can be selected according to the shape and dimensions of luggage N. Furthermore, storage space 11 can be increased if seat S can be folded and tilted (tumbled). In the examples described above, the luggage storage structure can selectively assume first and second forms. However, the present invention also includes a structure that can also assume other forms in addition to the first and second forms. For example, first movable panel 2 can be configured to be positioned not only in the first and second positions, but also in positions (not shown) above or below the first position. The present invention is particularly effective when the vehicle is an electric or hybrid vehicle, when battery 16 is located in the rear, and when there is space between seat S and the installation position of battery 16.

### EXPLANATION OF REFERENCE NUMERALS

1 floor member
2 first movable panel
3 second movable panel
4 flat surface portion
5 vertical wall portion 5
6 floor
7 interior panel
8 convex portion (convexo-concave portion)
8a groove
9 concave portion (convexo-concave portion)
10, 11 storage space
12a, 12b, 13 convex portion
14 thin portion
15 concave portion
16 battery
17 access door
18 box member
N luggage
S rear seat

1. A luggage storage structure comprising:
a flat surface portion of a floor member that is placed on a floor of a vehicle;
a vertical wall portion extending from the floor toward the interior of the vehicle;
a first movable panel that can be selectively positioned in a first position in which, along the flat surface portion, the first movable panel faces the flat surface portion and is spaced from the flat surface portion, and in a second position in which the first movable panel faces the flat surface portion and is closer to the flat surface portion than in the first position; and
a second movable panel that can be selectively positioned in a first position in which the second movable panel is adjacent to an end of the first movable panel opposite to the vertical-wall-portion side in the first position, in which the second movable panel is oriented in a direction that intersects with the flat surface portion, and in which the second movable panel faces the vertical wall portion and is spaced from the vertical wall portion, and in a second position in which the second movable panel overlaps the flat surface portion and the first movable panel in the second position, wherein
the luggage storage structure can selectively assume: a first form in which a storage space is formed surrounded by the first movable panel in the first position, the second movable panel in the first position, the vertical wall portion, and the flat surface portion; and a second form in which a storage space is at least partially defined in two directions and is formed by the vertical wall portion and stacked bodies comprising the first movable panel in the second position, the second movable panel in the second position, and the flat surface portion.

2. The luggage storage structure according to claim 1, wherein the vertical wall portion is integrally formed with the flat surface portion of the floor member.

3. The luggage storage structure according to claim 1, wherein the first movable panel in the first position can be opened and closed by pivoting around an end on the vertical-wall-portion side or around an end opposite to the vertical-wall-portion side.

4. The luggage storage structure according to claim 1, wherein at least one of the vehicle interior paneling and the floor member is provided with a convexo-concave portion that can hold the first movable panel in the first position and the second position, and a convexo-concave portion that can hold the second movable panel in the first position and the second position.

5. The luggage storage structure according to claim 1, wherein the first movable panel and the second movable panel each comprise a plurality of plate members, the plate members being unconnected and independent of each other.

6. The luggage storage structure according to claim 2, wherein the first movable panel in the first position can be opened and closed by pivoting around an end on the vertical-wall-portion side or around an end opposite to the vertical-wall-portion side.

7. The luggage storage structure according to claim 2, wherein at least one of the vehicle interior paneling and the floor member is provided with a convexo-concave portion that can hold the first movable panel in the first position and the second position, and a convexo-concave portion that can hold the second movable panel in the first position and the second position.

8. The luggage storage structure according to claim 2, wherein the first movable panel and the second movable panel each comprise a plurality of plate members, the plate members being unconnected and independent of each other.
